(19) United States
(12) Patent Application Publication
(10) Pub. No.: US 2017/0154587 A1
(43) Pub. Date: Jun. 1, 2017

(54) LIQUID CRYSTAL DISPLAY PANEL AND DRIVING METHOD THEREOF

(71) Applicant: Shenzhen China Star Optoelectronics Technology Co. Ltd., Shenzhen, Guangdong (CN)

(72) Inventors: Lixuan CHEN, Shenzhen, Guangdong (CN); Chih-tsung KANG, Shenzhen, Guangdong (CN)

(73) Assignee: Shenzhen China Star Optoelectronics Technology Co. Ltd., Shenzhen, Guangdong (CN)

(21) Appl. No.: 14/779,654

(22) PCT Filed: Aug. 25, 2015
(86) PCT No.: PCT/CN2015/088026

§ 371 Date: Sep. 24, 2015

(30) Foreign Application Priority Data
Jun. 11, 2015 (CN) 201510320828.X

(51) Int. Cl. G09G 3/36; G09G 3/20

(52) U.S. Cl. CPC G09G 3/3607; G09G 3/2003; G09G 3/3677; G09G 2300/0452; G09G 2300/0443; G09G 2320/0233

(57) ABSTRACT

The invention provides a liquid crystal display panel and a driving method thereof, the method includes: providing a liquid crystal display panel, which includes a pixel matrix of M×N, every pixel consists of a red sub-pixel, a green sub-pixel and a blue sub-pixel in sequence, making the LCD panel include a sub-pixel matrix of M×3N, aiming at the sub-pixel matrix, a dividing operation is executed, a first sub-pixel in the sub-pixel couple of each color is provided with a higher gray-scale value BH, a second sub-pixel in the sub-pixel couple of each color is provided with a lower gray-scale value BL, making a brightness curve of each sub-pixel at an angle of side view approach a scheduled Gamma curve. The liquid crystal display panel and the driving method thereof can reduce the color shift of the liquid crystal display panel when viewed at an angle of side view.

### BACKGROUND

1. Technical Field

The invention relates to the field of liquid crystal display technology, and more particularly to a liquid crystal display panel and a driving method thereof.

2. Description of the Related Art

A liquid crystal display (LCD) is a flat, super-thin display device, which consists of a number of colorful or black-and-white pixels, being placed in front of a light or a reflecting plate. Due to advantages such as low power consumption, high definition, small dimension and lightweight, the liquid crystal display is prevalent and being the mainstream. Liquid crystal displays are widely used in numerous electronic products, such as computers with screens, mobile phones or digital photo frames, and wide-angle technology is one of the development priorities. However, when the angle of side view is too wide, color shift of a wide-angle liquid crystal display can occur.

Aiming at solving the problem that the color shift of a wide-angle liquid crystal display device, a 2D1G technology is employed by industry as a solution. The term 2D1G technology means dividing every pixel into a main pixel and a sub pixel that have different areas, the main pixel and the sub pixel from the same pixel are connected to different data lines and the same gate line. Different display brightness and strabismus brightness are generated by inputting different data signals (different gray-scale values) to the main pixel and the sub pixel, which can reduce the color shift when viewed at an angle of side view. However, after dividing every pixel into a main pixel and a sub pixel, the amount of the data lines of input data signal doubles, which can decrease the aperture opening ratio of liquid crystal display panels a lot and influence the penetration rate, leading to a degrading performance of liquid crystal display panels.

### SUMMARY

Accordingly, the present invention provides a liquid crystal display panel and a driving method thereof, which can overcome the color shift when viewed at an angle of side view by altering the driving method of a liquid crystal display panel and simulating display of a 2D1G panel in a conventional RGB three-pixel liquid crystal display panel, otherwise, it also overcomes the problem that high quality images shift discontinuously due to a large variance of brightness caused by simply dividing all the blue sub-pixels for higher/lower gray-scale value drive.

An aspect of exemplary embodiment of the present invention provides a driving method of the liquid crystal display panel, which includes providing a liquid crystal display panel, the liquid crystal display panel includes a pixel matrix of M×N, where M and N are positive integers that are larger than 1, each pixel consists of a red sub-pixel, a green sub-pixel and a blue sub-pixel arranged in sequence, making the liquid crystal display panel includes a sub-pixel matrix of M×3N, in the sub-pixel matrix, a (m, 3n−2) sub-pixel indicates the red sub-pixel, a (m, 3n−1) sub-pixel indicates the green sub-pixel, a (m, 3n) sub-pixel indicates the blue sub-pixel, mε[1, 2, 3, . . . , M], nε[1, 2, 3, . . . , N]; aiming at the sub-pixel matrix, at least one of the following dividing operations is executed: part of the blue sub-pixels are divided into blue sub-pixel couples each consisting of a pair of blue sub-pixels, part of the red sub-pixels are divided into red sub-pixel couples each consisting of a pair of red sub-pixels, part of the green sub-pixels are divided into green sub-pixel couples each consisting of a pair of green sub-pixels; or aiming at the sub-pixel matrix, all the blue sub-pixels are divided into blue sub-pixel couples each consisting of a pair of blue sub-pixels, and at least one of the following dividing operations is executed: part of the red sub-pixels are divided into red sub-pixel couples each consisting of a pair of red sub-pixels, part of the green sub-pixels are divided into green sub-pixel couples each consisting of a pair of green sub-pixels, a higher gray-scale value BH is provided to a first blue sub-pixel of each of the blue sub-pixel couples, a lower gray-scale value BL is provided to a second blue sub-pixel of each of the blue sub-pixel couples; combination of the higher gray-scale value BH and the lower gray-scale value BL makes brightness curve of the blue sub-pixel at an angle of side view approach a scheduled Gamma curve; a higher gray-scale value RH is provided to a first red sub-pixel of each of the red sub-pixel couples, a lower gray-scale value RL is provided to a second red sub-pixel of each of the red sub-pixel couples; combination of the higher gray-scale value RH and the lower gray-scale value RL makes brightness curve of the red sub-pixel at an angle of side view approach the scheduled Gamma curve; a higher gray-scale value GH is provided to a first green sub-pixel of each of the green sub-pixel couples, a lower gray-scale value GL is provided to a second green sub-pixel of each of the green sub-pixel couples; combination of the higher gray-scale value GH and the lower gray-scale value GL makes brightness curve of the green sub-pixel at an angle of side view approach the scheduled Gamma curve.

Optionally, the first and the second blue sub-pixels of the blue sub-pixel couple can be adjacent sub-pixels in the same column of the blue sub-pixel or non-adjacent sub-pixels with a fixed interval; or the first and the second red sub-pixels of the red sub-pixel couple can be adjacent sub-pixels in the same column of the red sub-pixel or non-adjacent sub-pixels with a fixed interval; or the first and the second green sub-pixels of the green sub-pixel couple can be adjacent sub-pixels in the same column of the green sub-pixel or non-adjacent sub-pixels with a fixed interval.

Optionally, iε[1, 2, 3, . . . , M], jε[1, 2, 3, . . . , 3N−3], an (i, j) sub-pixel and an (i, j+3) sub-pixel can be provided the higher gray-scale value respectively at different times, and the (i, j) sub-pixel and the (i, j+3) sub-pixel can be provided the lower gray-scale value respectively at different times.

Optionally, aiming at a liquid crystal display panel with two sub-pixel couples dividing from a blue sub-pixel couple, a red sub-pixel couple and a green sub-pixel couple, pε[1, 2, 3, . . . , M], qε[1, 2, 3, . . . , 3N−1], a (p, q) sub-pixel and a (p, q+1) sub-pixel can be provided the higher gray-scale value respectively at different times, and the (p, q) sub-pixel and a (p, q+1) sub-pixel can be provided the lower gray-scale value respectively at different times.

Optionally, aiming at a liquid crystal display panel with three sub-pixel couples dividing from a blue sub-pixel couple, a red sub-pixel couple and a green sub-pixel couple, pε[1, 2, 3, . . . , M], qε[1, 2, 3, . . . , 3N−2], a (p, q) sub-pixel, a (p, q+1) sub-pixel and a (p, q+2) sub-pixel are provided the higher gray-scale value respectively at different times, and the (p, q) sub-pixel, the (p, q+1) sub-pixel and the (p, q+2) sub-pixel are provided the lower gray-scale value respectively at different times.

Optionally, the following sequence providing each of the blue sub-pixel couples with the higher gray-scale value BH and the lower gray-scale value BL is:

S101. obtaining a curve B₀−LvαB₀ that describes the relationship of the actual brightness and the gray-scale value of the blue sub-pixel of the liquid crystal display panel at an angle of front view α;

S102. obtaining a curve B₀−LvβB₀ that describes the relationship of the actual brightness and the gray-scale value of the blue sub-pixel of the liquid crystal display panel at an angle of side view β;

$${( \frac{B}{255} )}^{γ} = \frac{LvB}{Lv ( 255 )} ,$$

S103. according to a formula calculating the curves B−LvαB and B−LvβB describing the relationships of the theoretical brightness and gray-scale value of the blue sub-pixel of the liquid crystal display panel at the angles of front view α and side view β respectively;

S104. the higher gray-scale value BH provided to the first blue sub-pixel of the each of the blue sub-pixel couples and the lower gray-scale value BL provided to the second sub-pixel of the each of the blue sub-pixel couples satisfying:

Δ1=LvαB+LvαB−Lvα(BH)−Lvα(BL);

Δ2=LvβB+LvβB−Lvβ(BH)−Lvβ(BL);

y1=Δ1²+Δ2²;

where y1 takes the minimum value, values of LvαB and LvβB are read from the curves B-LvαB and B−LvβB, values of Lvα(BH) and Lvα(BL) are read from the curve B₀−LvαB₀, values of Lvβ(BH) and Lvβ(BL) are read from the curve B₀−LvβB₀;

S105. Each of the blue sub-pixel couples obtaining a corresponding combination of gray-scale values BH and BL according to step S104, recreating a display-search table of the blue sub-pixel of the liquid crystal display panel.

Optionally, the following sequence providing each of the green sub-pixel couples with the higher gray-scale value GH and the lower gray-scale value GL is:

S201. obtaining a curve G₀−LvαG₀ that describes the relationship of the actual brightness and the gray-scale value of the green sub-pixel of the liquid crystal display panel at an angle of front view α;

S202. obtaining a curve G₀−LvβG₀ that describes the relationship of the actual brightness and the gray-scale value of the green sub-pixel of the liquid crystal display panel at an angle of side view β;

S203. according to a formula

$${( \frac{G}{255} )}^{γ} = \frac{LvG}{Lv ( 255 )} ,$$

calculating the curves G−LvαG and G−LvβG describing the relationships of the theoretical brightness and gray-scale value of the green sub-pixel of the liquid crystal display panel at the angle of front view α and side view β respectively;

S204. the higher gray-scale value GH provided to the first green sub-pixel of the each of the green sub-pixel couples and the lower gray-scale value GL provided to the second sub-pixel of the each of the green sub-pixel couples satisfying:

Δ1=LvαG+LvαG−Lvα(GH)−Lvα(GL);

Δ2=LvβG+LvβG−Lvβ(GH)−Lvβ(GL);

y2=Δ1²+Δ2²;

where y2 takes the minimum value, values of LvαG and LvβG are read from curves G−LvαG and G−LvβG, values of Lvα(GH) and Lvα(GL) are read from the curve G₀−LvαG₀, values of Lvβ(GH) and Lvβ(GL) are read from the curve G₀−LvβG₀;

S205. Each of the green sub-pixel couples obtaining a corresponding combination of gray-scale values GH and GL according to step S204, recreating a display-search table of the green sub-pixel of the liquid crystal display panel.

Optionally, the following sequence providing each of the red sub-pixel couples with the higher gray-scale value RH and the lower gray-scale value RL is:

S301. obtaining a curve R₀−LvαR₀ that describes the relationship of the actual brightness and the gray-scale value of the red sub-pixel of the liquid crystal display panel at an angle of front view α;

obtaining a curve R₀−LvβR₀ that describes the relationship of the actual brightness and the gray-scale value of the red sub-pixel of the liquid crystal display panel at an angle of side view β;

S303. according to a formula

$${( \frac{R}{255} )}^{γ} - \frac{LvR}{Lv ( 255 )} ,$$

calculating the curves R−LvαR and R−LvβR describing the relationships of the theoretical brightness and the gray-scale value of the red sub-pixel of the liquid crystal display panel at the angle of front view α and side view β respectively;

S304. the higher gray-scale value RH provided to the first red sub-pixel of the each of the red sub-pixel couples and the lower gray-scale value RL provided to the second sub-pixel of the each of the red sub-pixel couples satisfying:

Δ1=LvαR−LvαR−Lvα(RH)−Lvα(RL);

Δ2=LvβR−LvβR−Lvβ(RH)−Lvβ(RL);

y3=Δ1²+Δ2²;

where y3 takes the minimum value, values of LvαR and LvβR are read from the curves R−LvαR and R−LvβR, values of Lvα (RH) and Lvα (RL) are read from the curve R₀−LvαR₀, values of Lvβ (RH) and Lvβ (RL) are read from the curve R₀−LvβR₀;

S305. Each of the red sub-pixel couples obtaining a corresponding combination of gray-scale values RH and RL according to step S304, recreating a display-search table of the red sub-pixel of the liquid crystal display panel.

Optionally, the front view α can be 0°, the side view β can be 30˜80°.

The present invention also provides a liquid crystal display panel, which includes a grid controller, a source controller and pixels, the grid controller provides scanning signals to the pixel by a number of scanning lines, the source controller provides data signals to the pixel by a number of data lines, the method for driving the liquid crystal display panel can be one of the previous methods.

### Advantages

The liquid crystal display panel and the driving method thereof according to the present invention can overcome the color shift when viewed at an angle of side view by altering the driving method of a conventional RGB three-pixel liquid crystal display panel and simulating display of the 2D1G panel without decreasing the aperture opening ratio of the liquid crystal display panel, otherwise, it also overcomes the problem that high quality images shift discontinuously due to a large variance of brightness caused by simply dividing all the blue sub-pixels for higher/lower gray-scale value drive, which can guarantee the quality of the images of the liquid crystal display panel.

### BRIEF DESCRIPTION OF THE DRAWINGS

In the following detailed description of the preferred embodiments, reference is made to the accompanying drawings which form a part hereof, and in which is shown by way of illustration specific embodiments in which the invention may be practiced.

FIG. 1 is a schematic structural view of a liquid crystal display panel according to an exemplary embodiment of the invention;

FIG. 2 is a schematic structural view of a pixel of the liquid crystal display panel according to an exemplary embodiment of the invention;

FIG. 3 is a flow chart of a driving method of the liquid crystal display panel according to an exemplary embodiment of the invention;

FIG. 4 is a schematic view of a sub-pixel matrix in the liquid crystal display panel according to an exemplary embodiment of the invention;

FIG. 5 is a schematic view of an array of blue sub-pixel couples according to an exemplary embodiment of the invention;

FIG. 6 is a flow chart of sequence that provides a blue sub-pixel couple with the higher gray-scale value BH and the lower gray-scale value BL according to an exemplary embodiment of the invention;

FIG. 7 is curves of actual brightness of front view and side view of the blue sub-pixel of the liquid crystal display panel according to an exemplary embodiment of the invention;

FIG. 8 is an example of regulation of providing a sub-pixel with a higher gray-scale value and a lower gray-scale value according to an exemplary embodiment of the invention;

FIG. 9 is an example of regulation of providing a sub-pixel with a higher gray-scale value and a lower gray-scale value according to another exemplary embodiment of the invention;

FIG. 10 is an example of regulation of providing a sub-pixel with a higher gray-scale value and a lower gray-scale value according to another exemplary embodiment of the invention;

### DETAILED DESCRIPTION

With the following reference to accompanying drawings, where the same label represents the same component. Concrete embodiments of the invention will be described in detail to better understand the invention.

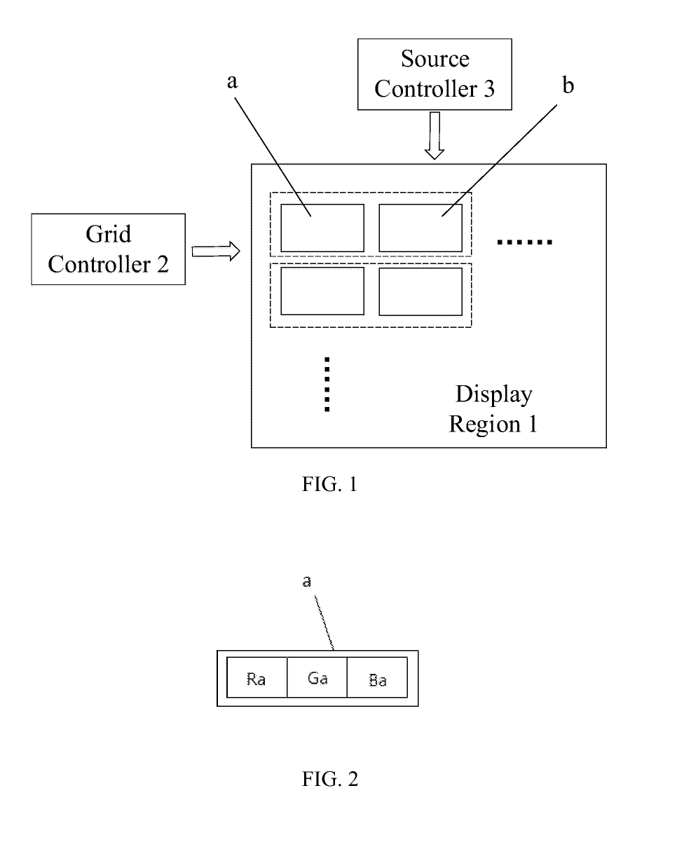

FIG. 1 is a schematic structural view of a liquid crystal display panel according to an exemplary embodiment of the invention. As shown in FIG. 1, the liquid crystal display panel can include a display region 1 with multiple pixels a and b, a grid controller 2 and a source controller 3, the grid controller 2 provides scanning signals to the pixels a and b by a number of scanning lines, the source controller 3 provides data signals to the pixels a and b by a number of data lines.

FIG. 2 is a schematic structural view of a pixel in the liquid crystal display panel according to an exemplary embodiment of the invention. Referring to FIG. 2, each pixel a includes a red sub-pixel Ra, a green sub-pixel Ga and a blue sub-pixel Ba.

The object of the exemplary embodiment is to overcome the color shift when viewed at an angle of side view by altering the driving method of the liquid crystal display panel and simulating display of the 2D1G panel in the above-described RGB three-pixel liquid crystal display panel.

The invention employs the following technical solution:

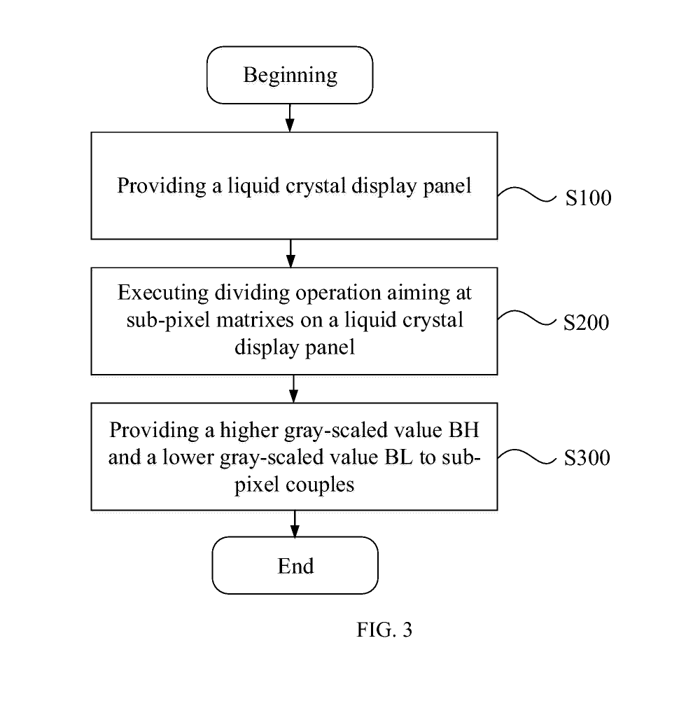

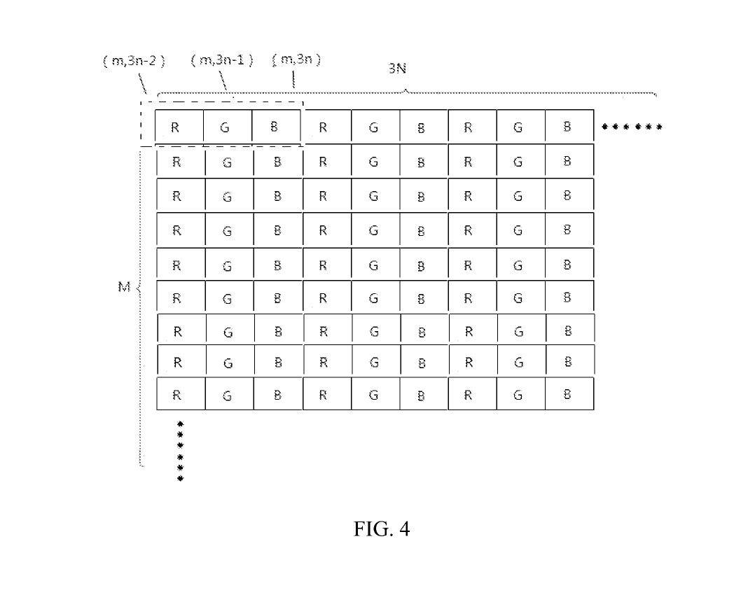

FIG. 3 is a flow chart of a driving method of the liquid crystal display panel according to an exemplary embodiment of the invention. Referring to FIG. 3, in the step S100, a liquid crystal display panel is provided, which includes a pixel matrix of M×N, where M and N are positive integers that larger than 1, every pixel consists of a red sub-pixel, a green sub-pixel and a blue sub-pixel arranged in sequence, making the liquid crystal display panel include a sub-pixel matrix of M×3N. FIG. 4 is a schematic view of a sub-pixel matrix of the liquid crystal display panel according to an exemplary embodiment of the invention.

Referring to FIG. 4, in the sub-pixel matrix, a (m, 3n−2) sub-pixel indicates a red sub-pixel R, a (m, 3n−1) sub-pixel indicates a green sub-pixel G, a (m, 3n) sub-pixel indicates a blue sub-pixel B, mε[1, 2, 3, . . . , M], nε[1, 2, 3, . . . , N].

In the step S200, aiming at the sub-pixel matrix, at least one of the following dividing operations is executed: part of the blue sub-pixels are divided into blue sub-pixel couples each consisting of a pair of blue sub-pixels, part of the red sub-pixels are divided into red sub-pixel couples each consisting of a pair of red sub-pixels, part of the green sub-pixels are divided into green sub-pixel couples each consisting of a pair of green sub-pixels; or aiming at the sub-pixel matrix, all of the blue sub-pixels are divided into blue sub-pixel couples each consisting of a pair of blue sub-pixels, and at least one of the following dividing operations is executed: part of the red sub-pixels are divided into red sub-pixel couples each consisting of a pair of red sub-pixels, part of the green sub-pixels are divided into green sub-pixel couples each consisting of a pair of green sub-pixels.

It can be figured out that at least one driving pattern consisting of part of the sub-pixels can be obtained according to the previous dividing operations, or a driving pattern consisting of all the blue sub-pixel and at least one from other sub-pixels, which can offset the imaging deficiency caused by simply dividing all the blue sub-pixels for higher gray-scale value/lower gray-scale value drive.

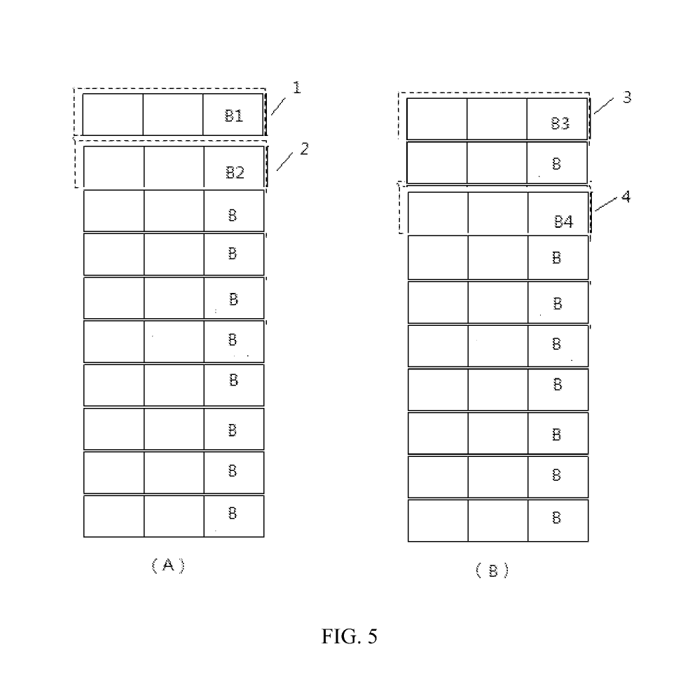

The composition of a blue sub-pixel couple will be illustrated by taking an example of blue sub-pixels accompanying FIG. 5.

Specifically, (A) in FIG. 5 is an example of an array of a blue sub-pixel couple according to an exemplary embodiment of the invention. To be more specific, referring to (A) in FIG. 5, a first blue sub-pixel 1 and a second blue sub-pixel 2 in the blue sub-pixel couple marked by dotted lines can be adjacent sub-pixels in the same column of a blue sub-pixel. (B) in FIG. 5 is another array of a blue sub-pixel couple according to an exemplary embodiment of the invention. To be more specific, referring to (B) in FIG. 5, a first blue sub-pixel 3 and a second blue sub-pixel 4 in the blue sub-pixel couple marked by dotted lines can be non-adjacent sub-pixels with a fixed interval in the same column of a blue sub-pixel, the fixed interval in FIG. 5(B) can be a blue sub-pixel as well as several blue sub-pixels, numeral is not limited.

Otherwise, based on the same dividing regulation, a first red sub-pixel and a second red sub-pixel in a red sub-pixel couple can be adjacent sub-pixels in the same column of the red sub-pixel or non-adjacent sub-pixels with a fixed interval; or a first green sub-pixel and a second green sub-pixel in a green sub-pixel couple can be adjacent sub-pixels in the same column of the green sub-pixel or non-adjacent sub-pixels with a fixed interval.

Referring again to FIG. 3, in the step S300, the first sub-pixel in the sub-pixel couple is provided with the higher gray-scale value, the second sub-pixel in the sub-pixel couple is provided with the lower gray-scale value.

The divided sub-pixel couples by the same color can be distributed based on the higher gray-scale value and the lower gray-scale value. Specifically, a first blue sub-pixel of each of the blue sub-pixel couples is provided with the higher gray-scale value BH, a second blue sub-pixel of each of the blue sub-pixel couples is provided with a lower gray-scale value BL; the higher gray-scale value BH and the lower gray-scale value BL are combined to make the brightness curve of the blue sub-pixel at an angle of side view approach a scheduled Gamma curve; a first red sub-pixel of each of the red sub-pixel couples is provided with the higher gray-scale value RH, a second red sub-pixel of each of the red sub-pixel couples is provided with the lower gray-scale value RL; the higher gray-scale value RH and the lower gray-scale value RL are combined to make the brightness curve of the red sub-pixel at an angle of side view approach the scheduled Gamma curve; a first green sub-pixel of each of the green sub-pixel couples is provided with the higher gray-scale value GH, a second green sub-pixel of each of the green sub-pixel couples is provided with the lower gray-scale value GL; the higher gray-scale value GH and the lower gray-scale value GL are combined to make the brightness curve of the green sub-pixel at an angle of side view approach the scheduled Gamma curve.

The Gamma (γ) curve can be defined depending on the requirement of the liquid crystal display panel, γ can be 1.8˜2.4. Taking the blue sub-pixel for example, the brightness curve of the blue sub-pixel at an angle of side view can be a successive curve formed by the average value of brightness of all the blue sub-pixel couples with different γ values.

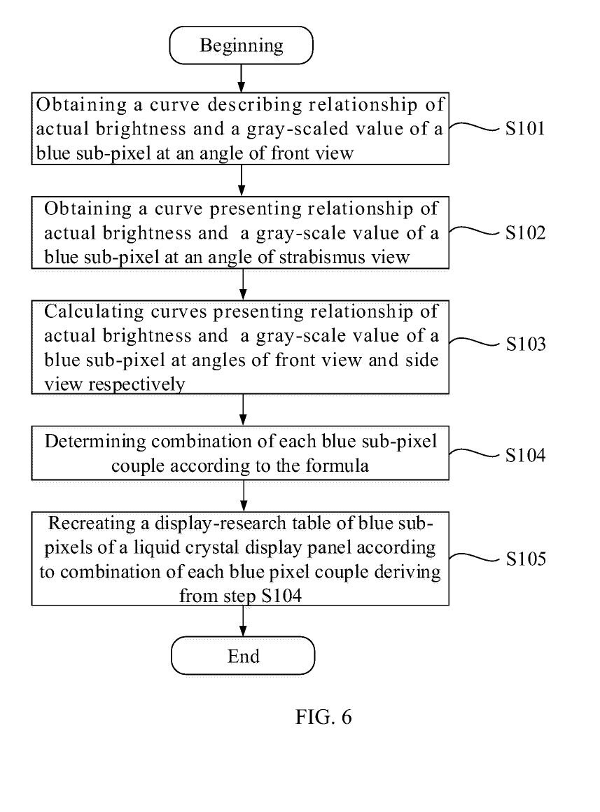

The angle of front view α can be 0°, the angle of side view β can be 30˜80°, the sequence that provides the blue sub-pixel couple with the higher gray-scale value BH and the lower gray-value BL is illustrated subsequently accompanying FIG. 6.

FIG. 6 is a flow chart of sequence that provides the blue sub-pixel couple with the higher gray-scale value BH and the lower gray-scale value BL according to an exemplary embodiment of the invention.

Referring to FIG. 6, in the step S101, a curve B₀−LvαB₀ that expresses the relationship of actual brightness and the gray-scale value of the blue sub-pixel of the liquid crystal display panel at the angle of front view α can be obtained;

In the step S102, a curve B₀−LvβB₀ that expresses the relationship of actual brightness and the gray-scale value of the blue sub-pixel of the liquid crystal display panel at the angle of side view β can be obtained;

In the step S103, according to a formula (B/255)^{γ}=LvB/Lv(255), curves B−LvαB and B−LvβB describing the relationships of the theoretical brightness and the gray-scale value of the blue sub-pixel of the liquid crystal display panel are calculated at angles of front view α and side view β respectively;

In the step S104, the higher gray-scale value BH provided to the first blue sub-pixel of the each of the blue sub-pixel couples and the lower gray-scale value BL provided to the second sub-pixel of the each of the blue sub-pixel couples satisfy:

Δ1=LvαB+LvαB−Lvα(BH)−Lvα(BL);

Δ2=LvβB+LvβB−Lvβ(BH)−Lvβ(BL);

y1=Δ1²+Δ2²;

where y1 takes the minimum value, values of LvαB and LvβB are read from curves B−LvαB and B−LvβB, values of Lvα(BH) and Lvα(BL) are read from the curve B₀−LvαB₀, values of Lvβ(BH) and Lvβ(BL) are read from the curve B₀−LvβB₀;

In the step S105, each of the blue sub-pixel couples obtains a corresponding combination of gray-scale values BH and BL according to step S104, a display-search table of the blue sub-pixel of the liquid crystal display panel is recreated.

Taking the example of γ=2.2, the angle of front view α=0°, the angle of side view β=60° in the scheduled curve Gamma(γ), the sequence that provides each of the blue sub-pixel couples with the higher gray-scale value BH and the lower gray-scale value BL will be illustrated.

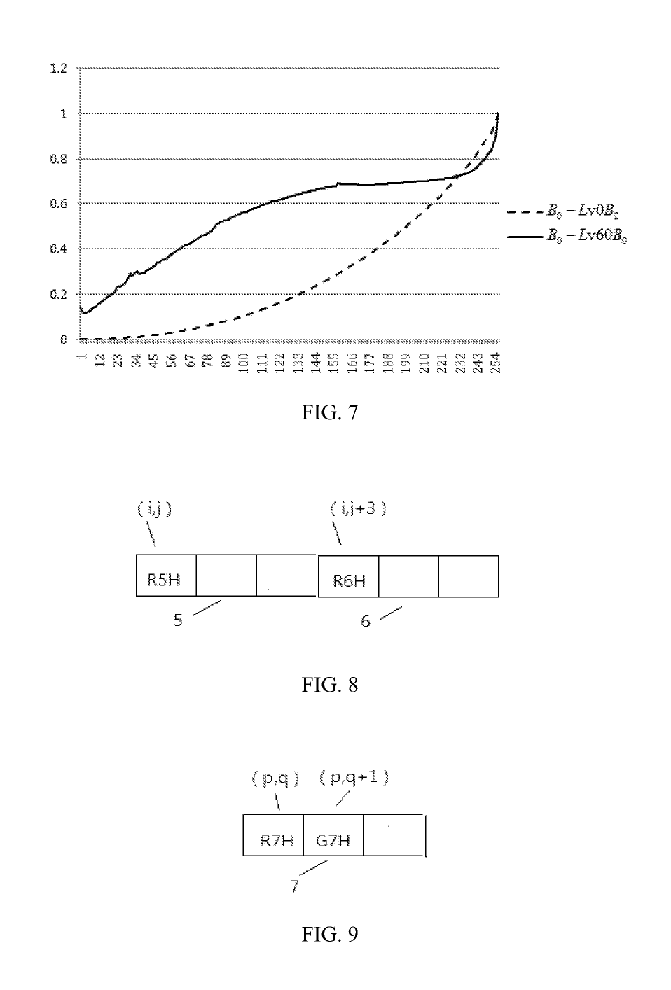

First, the curve B₀−Lv0B₀ describing the relationship of actual brightness and the gray-scale value at the angle of front view α=0° and the curve B₀−Lv60B₀ describing the relationship of actual brightness and the gray-scale value at the angle of side view β=60° of the blue sub-pixel of the liquid crystal display panel are obtained respectively. FIG. 7 is curves of actual brightness of front view and side view of the blue sub-pixel of the liquid crystal display panel according to an exemplary embodiment of the invention, the curves shown in FIG. 7. The gray-scale of the liquid crystal display panel includes 256 gray-scale values, which from 0 to 255.

Then, according to a formula

$${( \frac{B}{255} )}^{γ} = \frac{LvB}{Lv ( 255 )} ,$$

curves B−Lv0B and B−Lv60B describing the relationships of the theoretical brightness and the gray-scale value of the blue sub-pixel of the liquid crystal display panel at the angle of front view α=0° and side view β=60° are calculated respectively. In the formula, when the angle of front view α=0°, Lv(255) is a brightness value according to the curve B₀−Lv0B₀ when B₀=255, when the angle of side view β=60°, Lv(255) is a brightness value according to the curve B₀−Lv60B₀ when B₀=255.

Furthermore, a higher gray-scale value B1H provided to the first blue sub-pixel 1 of the each of the blue sub-pixel couples and a lower gray-scale value B2L provided to the second sub-pixel 2 of the each of the blue sub-pixel couples satisfy:

Δ1=Lv0B−Lv0B−Lv0(B1H)−Lv0(B2L);

Δ2=Lv60R−Lv60R−Lv60(B1H)−Lv60(B2L);

y1=Δ1²+Δ2²;

The values of Lv0B and Lv60B can be searched from theoretical curves B−Lv0B and B−Lv60B, the values of Lv0(B1H) and Lv0(B2L) can be searched from the actual brightness curve B₀−Lv0B₀, the values Lv60(B1H) and Lv60(B2L) can be searched from the actual brightness curve B₀−Lv60B₀, the corresponding gray-scale values of B1H and B2H can be obtained by taking the minimum value of y in the previous formula.

Finally, a corresponding combination of B1H and B2L is obtained based on the above calculation, a display-search table of the blue sub-pixel of the liquid crystal display panel is recreated. When driving a liquid crystal display panel, if an image appears, the gray-scale value B1H provided to a blue sub-pixel B1 in a first pixel 1 and the gray-scale value B2L provided to a blue sub-pixel B2 in a second pixel 2 are searched from the display-search table.

In addition, the red or green sub-pixel couples can be provided with the corresponding higher gray-scale value and the lower gray-scale value, the repetitious description is omitted.

As a preferred proposal, when providing the higher gray-scale value and the lower gray-scale value to each sub-pixel couple, the interaction of the sub-pixels with the same color or the sub-pixels that are adjacent can be considered, specific pattern can be formed to guarantee the quality of images of a liquid crystal display panel.

Following is an example of regulation of providing each sub-pixel with a higher gray-scale value and a lower gray-scale value in the liquid crystal display shown in FIG. 4 according to FIG. 8 to FIG. 11.

As an exemplary embodiment shown in FIG. 8, iε[1, 2, 3, . . . , M], jε[1, 2, 3, . . . , 3N−3], an (i, j) sub-pixel and an (i, j+3) sub-pixel are provided the higher gray-scale value respectively at different times, and the (i, j) sub-pixel and the (i, j+3) sub-pixel are provided with the lower gray-scale value respectively at different times. In other words, to the sub-pixels with the same color, the sub-pixels in adjacent pixels will not be provided the higher gray-scale value and the lower gray-scale value simultaneously.

As an exemplary embodiment shown in FIG. 9, aiming at the liquid crystal display panel with two sub-pixel couples dividing from a blue sub-pixel couple, a red sub-pixel couple and a green sub-pixel couple, pε[1, 2, 3, . . . , M], qε[1, 2, 3, . . . , 3N−1], which can satisfy the regulation shown in FIG. 8, taking a step forward, a (p, q) sub-pixel and a (p, q+1) sub-pixel are provided with the higher gray-scale values respectively at different times, and the (p, q) sub-pixel and a (p, q+1) sub-pixel are provided with the lower gray-scale values respectively at different times, and the (p, q) sub-pixel and the (p, q+1) sub-pixel are provided with the lower gray-scale values respectively at different times. In other words, under the circumstance that only the higher gray-scale value and the lower gray-scale value are provided to the sub-pixels with two colors in the liquid crystal display panel, the adjacent sub-pixels with two colors will not be provided with the higher gray-scale values or the lower gray-scale values simultaneously.

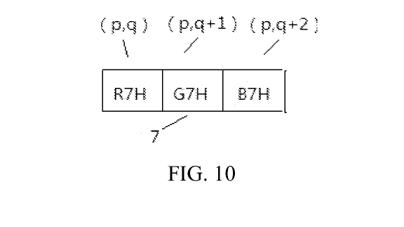

As an exemplary embodiment shown in FIG. 10, aiming at the liquid crystal display panel with three sub-pixel couples dividing from a blue sub-pixel couple, a red sub-pixel couple and a green sub-pixel couple, which can satisfy the regulation shown in FIG. 8, taking a step forward, pε[1, 2, 3, . . . , M], qε[1, 2, 3, . . . , 3N−2], a (p, q) sub-pixel, a (p, q+1) sub-pixel and a (p, q+2) sub-pixel are provided with the higher gray-scale values respectively at different times, and the (p, q) sub-pixel, the (p, q+1) sub-pixel and the (p, q+2) sub-pixel are provided with the lower gray-scale values respectively at different times. In other words, under the circumstance that the higher gray-scale value and the lower gray-scale value are provided to the sub-pixels with three colors in the liquid crystal display panel, the three adjacent sub-pixels will not be provided the higher gray-scale values or the lower gray-scale values simultaneously.

The exemplary embodiment of the present invention provides a liquid crystal display panel and a driving method thereof, which can overcome the color shift when viewed at an angle of side view by altering the driving method of the liquid crystal display panel and simulating display of the 2D1G panel in a conventional RGB three-pixel liquid crystal display panel without decreasing the aperture opening ratio of the liquid crystal display panel, otherwise, it also overcomes the problem that high quality images shift discontinuously due to a large variance of brightness caused by simply dividing all the blue sub-pixels for higher/lower gray-scale value drive, which can guarantee the quality of images of a liquid crystal display panel.

Obviously, the above description illustrates various exemplary embodiments to explain the principles and implementations of the invention. For those skilled persons in the art, various modifications and variations can be made according to the concept of the invention, and therefore the invention needs not be limited to the disclosed embodiment. It is intended to cover various modifications and similar arrangements included within the spirit and scope of the appended claims which are to be accorded with the broadest interpretation so as to encompass all such modifications and similar structures.

What is claimed is:

1. A method for driving a liquid crystal display panel, comprising:
providing a liquid crystal display panel, the liquid crystal display panel comprising a pixel matrix of M×N, where M and N are positive integers that are larger than 1 respectively, each pixel comprising a red sub-pixel, a green sub-pixel and a blue sub-pixel arranged in sequence, resultingly the liquid crystal display panel comprising a sub-pixel matrix of M×3N, in the sub-pixel matrix, a (m, 3n−2) sub-pixel indicating the red sub-pixel, a (m, 3n−1) sub-pixel indicating the green sub-pixel, a (m, 3n) sub-pixel indicating the blue sub-pixel, mε[1, 2, 3, . . . , M], nε[1, 2, 3, . . . , N];
Aiming at the sub-pixel matrix, executing at least one of the following dividing operations: dividing part of the blue sub-pixels into blue sub-pixel couples each consisting of a pair of blue sub-pixels, dividing part of the red sub-pixels into red sub-pixel couples each consisting of a pair of red sub-pixels, dividing part of the green sub-pixels into green sub-pixel couples each consisting of a pair of green sub-pixels; or aiming at the sub-pixel matrix, dividing all of the blue sub-pixels into blue sub-pixel couples each consisting of a pair of blue sub-pixels, and executing at least one of the following dividing operations: dividing part of the red sub-pixels into red sub-pixel couples each consisting of a pair of red sub-pixels, dividing part of the green sub-pixels into green sub-pixel couples each consisting of a pair of green sub-pixels,
providing a higher gray-scale value BH to a first blue sub-pixel of each of the blue sub-pixel couples, providing a lower gray-scale value BL to a second blue sub-pixel of each of the blue sub-pixel couples; combining the higher gray-scale value BH and the lower gray-scale value BL to make a brightness curve of the blue sub-pixel at an angle of side view approach a scheduled Gamma curve; providing a higher gray-scale value RH to a first red sub-pixel of each of the red sub-pixel couples, providing a lower gray-scale value RL to a second red sub-pixel of each of the red sub-pixel couples; combining the higher gray-scale value RH and the lower gray-scale value RL to make a brightness curve of the red sub-pixel at an angle of side view approach the scheduled Gamma curve; providing a higher gray-scale value GH to a first green sub-pixel of each of the green sub-pixel couples, providing a lower gray-scale value GL to a second green sub-pixel of each of the green sub-pixel couples; combining the higher gray-scale value GH and the lower gray-scale value GL to make a brightness curve of the green sub-pixel at an angle of side view approach the scheduled Gamma curve.

2. The method according to claim 1, wherein a first and a second blue sub-pixels of the blue sub-pixel couple are adjacent sub-pixels in the same column of the blue sub-pixels or non-adjacent sub-pixels with a fixed interval; or a first and a second red sub-pixels of the red sub-pixel couple are adjacent sub-pixels in the same column of the red sub-pixels or non-adjacent sub-pixels with a fixed interval; or a first and a second green sub-pixels of the green sub-pixel couple are adjacent in the same column of the green sub-pixels or non-adjacent sub-pixels with a fixed interval.

3. The method according to claim 2, wherein iε[1, 2, 3, . . . , M], jε[1, 2, 3, . . . , 3N−3], an (i, j) sub-pixel and an (i, j+3) sub-pixel are provided with the higher gray-scale values respectively at different times, and the (i, j) sub-pixel and the (i, j+3) sub-pixel are provided with the lower gray-scale values respectively at different times.

4. The method according to claim 3, wherein aiming at the liquid crystal display panel with two sub-pixel couples dividing from a blue sub-pixel couple, a red sub-pixel couple and a green sub-pixel couple, pε[1, 2, 3, . . . , M], qε[1, 2, 3, . . . , 3N−1], a (p, q) sub-pixel and a (p, q+1) sub-pixel are provided with the higher gray-scale values respectively at different times, the (p, q) sub-pixel and the (p, q+1) sub-pixel are provided with the lower gray-scale values respectively at different times.

5. The method according to claim 3, wherein aiming at the liquid crystal display panel with three sub-pixel couples dividing from a blue sub-pixel couple, a red sub-pixel couple and a green sub-pixel couple, pε[1, 2, 3, . . . , M], qε[1, 2, 3, . . . , 3N−2], a (p, q) sub-pixel, a (p, q+1) sub-pixel and a (p, q+2) sub-pixel are provided with the higher gray-scale values respectively at different times, and the (p, q) sub-pixel, the (p, q+1) sub-pixel and the (p, q+2) sub-pixel are provided with the lower gray-scale values respectively at different times.

6. The method according to claim 1, wherein the sequence that provides each of the blue sub-pixel couples with the higher gray-scale value BH and the lower gray-scale value BL is:
S101, obtaining the curve B₀−LvαB₀ that describes the relationship of the actual brightness and the gray-scale value of the blue sub-pixel of the liquid crystal display panel at an angle of front view α;
S102, obtaining the curve B₀−LvβB₀ that describes the relationship of the actual brightness and the gray-scale value of the blue sub-pixel of the liquid crystal display panel at an angle of side view β;
S103, according to a formula
$${( \frac{B}{255} )}^{γ} = \frac{LvB}{Lv ( 255 )} ,$$
calculating the curves B−LvαB and B−LvβB describing the relationships of the theoretical brightness and gray-scale value of the blue sub-pixel of the liquid crystal display panel at angles of front view α and side view β respectively;
S104, the higher gray-scale value BH provided to the first blue sub-pixel of the each of the blue sub-pixel couples and the lower gray-scale value BL provided to the second sub-pixel of the each of the blue sub-pixel couples satisfying:
Δ1=LvαB+LvαB−Lvα(BH)−Lvα(BL);
Δ2=LvβB+LvβB−Lvβ(BH)−Lvβ(BL);
y1=Δ1²+Δ2²;
where y1 takes the minimum value, values of LvαB and LvβB are read from curves B−LvαB and B−LvβB, values of Lvα(BH) and Lvα(BL) are read from the curve B₀−LvαB₀, values of Lvβ(BH) and Lvβ(BL) are read from the curve B₀−LvβB₀;
S105, each of the blue sub-pixel couples obtaining a corresponding combination of gray-scale values BH and BL according to step S104, recreating a display-search table of the blue sub-pixel of the liquid crystal display panel.

7. The method according to claim 1, wherein the sequence that provides each of the green sub-pixel couples with the higher gray-scale value GH and the lower gray-scale value GL is:
S201, obtaining the curve G₀−LvαG₀ that describes the relationship of the actual brightness and the gray-scale value of the green sub-pixel of the liquid crystal display panel at an angle of front view α;
S202, obtaining the curve G₀−LvβG₀ that describes the relationship of the actual brightness and the gray-scale value of the green sub-pixel of the liquid crystal display panel at an angle of side view β;
S203, according to a formula
$${( \frac{G}{255} )}^{γ} = \frac{LvG}{Lv ( 255 )} ,$$
calculating the curves G−LvαG and G−LvβG describing the relationships of the theoretical brightness and gray-scale value of the green sub-pixel of the liquid crystal display panel at angles of front view α and side view β respectively;
S204, the higher gray-scale value GH provided to the first green sub-pixel of the each of the green sub-pixel couples and the lower gray-scale value GL provided to the second sub-pixel of the each of the green sub-pixel couples satisfying:
Δ1=LvαG+LvαG−Lvα(GH)−Lvα(GL);
Δ2=LvβG+LvβG−Lvβ(GH)−Lvβ(GL);
y2=Δ1²+Δ2²;
where y2 takes the minimum value, values of LvαG and LvβG are read from curves G−LvαG and G−LvβG, values of Lvα(GH) and Lvα(GL) are read from the curve G₀−LvαG₀, values of Lvβ(GH) and Lvβ(GL) are read from the curve G₀−LvβG₀;
S205, each of the green sub-pixel couples obtaining a corresponding combination of gray-scale values GH and GL according to step S204, recreating a display-search table of the green sub-pixel of the liquid crystal display panel.

8. The method according to claim 1, wherein the sequence that provides each of the red sub-pixel couples with the higher gray-scale value RH and the lower gray-scale value RL is:
S301, obtaining the curve R₀−LvαR₀ that describes the relationship of the actual brightness and the gray-scale value of the red sub-pixel of the liquid crystal display panel at an angle of front view α;
S302, obtaining the curve R₀−LvβR₀ that describes the relationship of the actual brightness and the gray-scale value of the red sub-pixel of the liquid crystal display panel at an angle of side view β;
S303, according to a formula
$${( \frac{R}{255} )}^{γ} - \frac{LvR}{Lv ( 255 )} ,$$
calculating the curves R−LvαR and R−LvβR describing the relationships of the theoretical brightness and gray-scale value of the red sub-pixel of the liquid crystal display panel at angles of front view α and side view β respectively;
S304, the higher gray-scale value RH provided to the first red sub-pixel of the each of the red sub-pixel couples and the lower gray-scale value RL provided to the second sub-pixel of the each of the red sub-pixel couples satisfying:
Δ1=LvαR−LvαR−Lvα(RH)−Lvα(RL);
Δ2=LvβR−LvβR−Lvβ(RH)−Lvβ(RL);
y3=Δ1²+Δ2²;
where y3 takes the minimum value, values of LvαR and LvβR are read from curves R−LvαR and R−LvβR, values of Lvα (RH) and Lvα (RL) are read from the curve R₀−LvαR₀, values of Lvβ (RH) and Lvβ (RL) are read from the curve R₀−LvβR₀;
S305, each of the red sub-pixel couples obtaining a corresponding combination of gray-scale values RH and RL according to step S304, recreating a display-search table of the red sub-pixel of the liquid crystal display panel.

9. The method according to claim 6, wherein the angle of front view α is 0°, the angle of strabismus view β is 30˜80°.

10. A liquid crystal display panel, comprising a grid controller, a source controller and pixels, the grid controller providing scanning signals to the pixels by a plurality of scanning lines, the source controller providing data signals to the pixels by a plurality of data lines, wherein the method for driving the liquid crystal display panel is the one described in claim 1.
